(19) United States
(12) Patent Application Publication
(10) Pub. No.: US 2015/0199228 A1
(43) Pub. Date: Jul. 16, 2015

(54) CONDITIONAL BRANCH PROGRAMMING TECHNIQUE

(71) Applicant: Geoffrey Roeder Pike, San Francisco, CA (US)

(72) Inventor: Geoffrey Roeder Pike, San Francisco, CA (US)

(73) Assignee: Google Inc., Mountain View, CA (US)

(21) Appl. No.: 13/605,936

(22) Filed: Sep. 6, 2012

(51) Int. Cl. G06F 9/44; G06F 11/36

(52) U.S. Cl. CPC G06F 11/0763; G06F 11/3688; G06F 8/30

(57) ABSTRACT

Various aspects of the subject technology relate to a programming technique for coding a conditional branch instruction. A system for executing programming code may include a processor and a machine-readable medium comprising instructions stored therein, which when executed by a processor, cause the processor to perform operations. The operations may comprise determining whether a condition exists within a portion of code, causing, if the condition exists, another portion of code to intentionally fail when executed by a processor, and executing the other portion of code, wherein the executing of the other portion of code fails if the condition exists.

### BACKGROUND

The present disclosure generally relates to generating programming code and, in particular, to coding techniques for a conditional branch.

More and more devices and machines may include components that are configured to execute computer programming code. For example, devices such as computers, smart phones, tablets, or mobile devices such as navigation devices may include machine-readable media and a processor that may execute computer programming code. Even cars or appliances such as refrigerators, televisions, or coffee makers include components that can execute computer programming code.

Computer programming code, whether in the form of high-level programming languages (e.g., source code), object code, or machine code written in an assembly language, often use branch instructions in which one portion of code is executed if a condition is met and another portion of code is executed if another condition is met.

### SUMMARY

Various aspects of the subject technology relate to a machine-readable medium including instructions stored therein, which when executed by a machine, cause the machine to perform operations. The operations may include determining whether a condition exists within a portion of code, causing, if the condition exists, another portion of code to intentionally fail when executed by a processor, and executing the other portion of code, wherein the executing of the other portion of code fails if the condition exists.

Various aspects of the subject technology relate to a system for executing programming code. The system may include a processor and a machine-readable medium comprising instructions stored therein, which when executed by a processor, cause the processor to perform operations. The operations may include determining whether a condition exists within a portion of the programming code, changing, if the condition exists, a value used by a subsequent line of programming code to cause the subsequent line of programming code to intentionally fail when subsequently executed by a processor, and executing the subsequent line of programming code, wherein the executing of the subsequent line of programming code fails if the condition exists and the executing of the subsequent line of programming code does not fail if the condition does not exist.

Various aspects of the subject technology relate to a computer-implemented method for coding a conditional branch. The method may include generating programming code configured to determine whether a condition exists in a portion of code, cause, if the condition exists, another portion of code to intentionally fail when executed by a processor, and execute the other portion of code, wherein the executing of the other portion of code fails if the condition exists.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed aspects and together with the description serve to explain the principles of the disclosed aspects.

FIG. 1 is a block diagram illustrating an example system in which computer programming code generated using a programming technique for implementing a branch operation may be executed, in accordance with various aspects of the subject technology.

FIG. 2 is a flow chart illustrating an example process that occurs when computer programming code generated using a programming technique is executed, in accordance with various aspects of the subject technology.

FIG. 3 is a block diagram illustrating a computer system with which any of the clients, servers, or systems described herein may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology.

Computer programming code often includes branch instructions. However these branch instructions often are not coded in an optimal way in terms of code size, running time, power consumption, or use of other computing resources. For example, conditional branches may use space in hardware caches, translation lookaside buffers (TLBs), circuits such as branch predictors, or other resources.

Various aspects of the subject technology relate to a programming technique for implementing a branch operation that, in some situations, is more optimal (e.g., the code is more compact). In one variation, the branch operation may be implemented without using a branch instructions such as, for example, “jump” instructions which transfer program control to instructions at a particular memory location or “conditional jump” instructions which transfer program control to instructions at a particular memory location if a condition is met. Instead of using branch instructions, the programming code may include an operation that causes a subsequently executed line of code to intentionally fail if a condition is met.

According to some aspects, the subsequently executed line of code may have preconditions that will be checked by, for example, hardware (e.g., a CPU) or software. Accordingly, the subsequently executed line of code may be caused to fail by forcing one or more of those preconditions to be violated. For example, a line of code that uses a function pointer may check to see that the function pointer points to memory that is marked as executable. The line of code may be caused to fail by setting the function pointer to memory that is marked as non-executable.

In some aspects, when the subsequently executed line of code fails, a fault message may be generated and provided to the system's operating system. The operating system may detect the fault message and use the information contained in the fault message to respond to the fault message by, for example, notifying the user or application of the fault or performing other actions in response to the fault message.

By implementing a branch operation using an operation that causes a subsequently executed line of code to intentionally fail if a condition is met, the execution of the computer programming code may be more efficient in the use of computing resources under certain conditions (e.g., conditions that are unlikely to happen). The programming technique, in some cases, may result in shorter and more compact programming code, shorter running time, less power consumption, or a combination of these or other results.

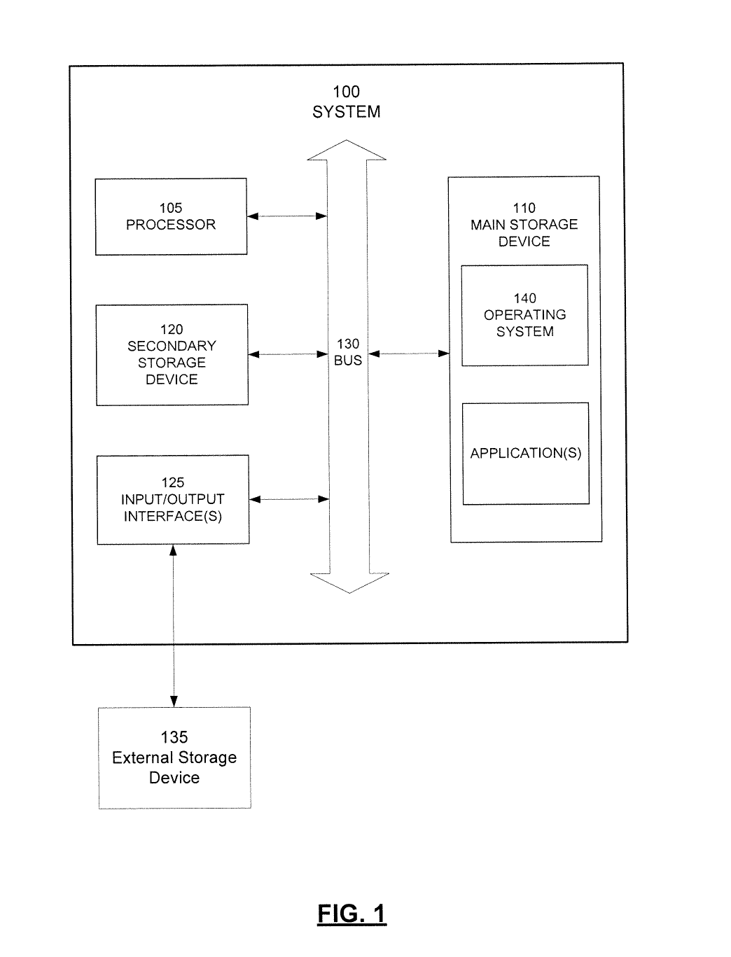

FIG. 1 is a block diagram illustrating an example system 100 in which computer programming code generated using a programming technique for implementing a branch operation may be executed, in accordance with various aspects of the subject technology. The system 100 can be implemented as a computer, a device, or any other machine or component capable of executing programming code. While the system 100 is shown in one configuration in FIG. 1, in other configurations, the system 100 may include additional, alternative, and/or fewer components.

The system 100 may include a processor 105, a main storage device 110, a secondary storage device 120, and one or more input/output interfaces 125 which may all communicate with one another via a bus 130. The one or more input/output interfaces 125 may be configured to communicate with various input/output devices such as video display units (e.g., liquid crystal (LCD) displays, cathode ray tubes (CRTs), or touch screens), an alphanumeric input device (e.g., a keyboard), a cursor control device (e.g., a mouse), or a signal generation device (e.g., a speaker). One or more input/output interfaces 125 may also be configured to communicate with an external storage device 135.

The processor 105 may be configured to control the various components of the system 100 and perform various tasks by executing machine-readable instructions (e.g., computer programming code) that are stored in the main storage device 110, the secondary storage device 120, or the external storage device 135.

The main storage device 110 may include cache memory, random access memory, or one or more hard drives. The main memory device may contain one or more sets of machine-readable instructions that may be executed by the processor in one or more sequences. For example, the main memory device 110, as seen in FIG. 1, includes a root file system that includes an instance of an operating system 140 for the computer system 100 as well as one or more applications.

Other applications or machine-readable code may also reside on the secondary storage device 120 or external storage device 135. The secondary storage device 120 may be a secondary hard drive, an internal memory card (e.g., a secure digital (SD) card or other flash card), a non-removable internal memory chip, or some other memory device. Similarly, the external storage device 135 may be a removable data storage device such as a universal serial bus (USB) drive or a secure digital (SD) card. The external storage device 135 may also take other forms (e.g., an external hard drive).

As discussed above, various aspects of the subject technology relate to a programming technique that can be used to implementing a branch operation without using a branch instructions. Instead, the computer programming code may be written to include an operation that causes a subsequently executed line of code to intentionally fail if a condition is met.

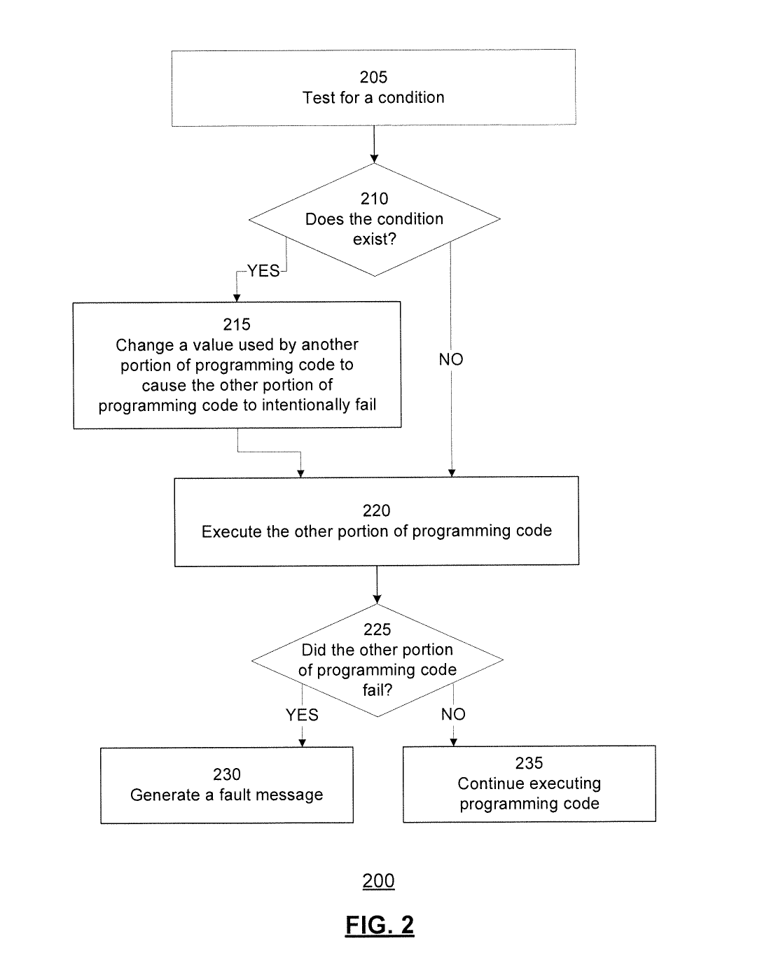

FIG. 2 is a flow chart illustrating an example process 200 that occurs when computer programming code generated using the programming technique is executed, in accordance with various aspects of the subject technology. Although the steps are shown in one particular order, other orderings of steps are also possible. Furthermore, the steps in process 200 may be a part of a larger process.

At step 205, the execution of the computer programming code causes a processor to test for a condition. For example, the computer programming code execute to perform one or more functions or operations. At some point in the execution of the computer programming code, the computer programming code may check if an error condition exists, if one variable is greater than, equal to, or less than, another variable or value, or any other condition that may be tested for using computer programming code. At step 210, it is determined whether or not the condition exists.

If the condition exists, at step 215, one or more instructions in the computer programming code is configured to change a value used by a another portion of programming code (e.g., the next line or a subsequent line) that will be executed such that the other portion of programming code will fail when it is executed. For example, if the other portion of programming code uses a variable, the variable may be set to an invalid value. If the other portion of programming code requires a location for executable code, the location may be set to non-executable code or another faulty value. Other values may also be changed such that the other portion of programming code will fail when it is executed. If the condition does not exist, the one or more instructions in the computer programming code will not change the value used in the other portion of programming code and the computer programming code will continue to execute normally.

For example, at step 220, the other portion of programming code is executed. If the condition tested for at step 205 does not exist, the other portion of programming code will execute without any changes in values to intentionally cause the other portion to fail. In other words, at step 225, the other portion of programming code executes normally and does not fail as a result of a changed value. Accordingly, at step 235, the programming code continues to execute normally.

If the condition tested for at step 205 does exist, the other portion of programming code will fail when executed at step 220. The failure of the other portion of programming code at step 220 may cause a fault message to be generated at step 230 and provided to the operating system.

According to some aspects, the process 200 may also include determining the reason that the failure occurred. For example, the location of the line that failed, the one or more preconditions of the failed line that were violated, and the values of other relevant variables may be determined and recorded. The information may also be included in the fault message generated at step 230.

An example of the subject technology will now be described using pseudo code. In some aspects, a compiler may read programming language code written by a programmer (human or otherwise) that includes a branch operation where certain code is to be executed if a failure condition is met. For example, the programming language code may include the following pseudo source code in the C programming language:

if (result < 0) { goto fail; }
else { return (*func_ptr)(result) + 1; }

Instead of generating the following code in assembly language:

test %rdi, %rdi
js fail
call (%rax)
inc %rax
leave
ret
...
fail:
...

the compiler, in accordance with various aspects of the subject technology, may generate the following code in assembly code that may be more efficient under certain conditions.

| | |
|---|---|
| test %rdi, %rdi | |
| cmovs %rsp, %rax | // If %rdi < 0, make %rax point to a |
| | // non-executable page. |
| call *(%rax) | // This will fault if %rdi < 0. |
| inc %rax | |
| leave | |
| ret | |

As is seen in the illustrative example above, the generated code may include a “test” instruction that will set a sign flag if the value in % rdi is less than 0. This corresponds to “result <0” in the source code. Next, the generated code contains a conditional move instruction “cmovs” that will check the sign flag and intentionally cause the next line of code (the “call” instruction) to fail if % rdi is less than 0 (“result <0” in the source code). The “cmovs” instruction will cause the “call” instruction to fail by causing a precondition of the “call” instruction (e.g., that % rax points to executable memory) to be violated by making % rax point to non-executable code.

In other aspects, other instructions may be used to cause the next line of code to fail. For example, the “cmovs % rsp, % rax” may be replaced with “cmovs % rax, % rsp.”

Accordingly, if the condition is met (e.g., % rdi is less than 0), the next line of the code (the “call” instruction) will fail when it is executed. If the condition is not met, the next line of code will not fail and subsequent lines of code will execute normally. By intentionally causing a subsequently executed line of code to intentionally fail, aspects of the subject technology provide for a method of implementing a branch operation without explicitly using branch instructions. In some cases, this may result in more compact code and code that requires fewer computing resources to execute (e.g., less space in a system's hardware caches is used).

The code that causes a subsequently executed line of code to fail may cause the subsequently executed line of code to fail by, for example, changing a variable needed by the subsequently executed line of code to an invalid value or changing a memory location needed by the subsequently executed line of code to an invalid memory location (e.g., a memory location for non-executable code).

When the subsequently executed line of code fails, a fault message can be generated and provided to the system's operating system or another application running on the system. The fault message may include various information that may be used to determine characteristics of the failure. For example, the fault message may include the location of the line of code that failed, the line of code that failed, a failure code that indicates the type of failure that occurred, and the values of certain variable, flags, or registers when the line of code failed.

In some aspects, code that is configured to save certain values may be used before the instruction that will intentionally cause the next line of code to fail. For example, to code the pseudo source code: if (result <0) goto foo; else f( )), a code generator (e.g., a compiler, a human programmer, or other application) may generate the following code in assembly language:

test %rdi, %rdi
cmovs %rax, %rsp
call *(%rax)

However, the former value of % rsp may be difficult to determine after the fault message is generated. Accordingly, one alternative is for the code generator to generate the following code in assembly language:

| | |
|---|---|
| test %rdi, %rdi | |
| mov %rsp, %fs:(%rsi) | // save %rsp to thread-local storage |
| | // in case it is needed to respond to the |
| | // fault message |
| cmovs %rax, %rsp | |
| call *(%rax) | |

The operating system or other application may detect the fault message and use the information contained in the fault message to respond to the fault message by, for example, notifying the user or another application of the fault message or performing other actions in response to the fault message. In some variations, the application or operating system may perform actions that are not limited to fault handling. For example, the application or operating system may determine, based on the fault message that an unlikely condition exists and performs a series of operations based on the existence of the unlikely condition.

In various aspects of the subject technology, other instructions may be used that will cause a fault message to be generated depending on the context in which the instructions are being executed. For example, in another illustrative example stack canaries may be used to detect a stack buffer overflow. Accordingly, instead of causing a failure, an instruction can cause a subsequent line of code to generate a fault message. More specifically, an instruction may induce a change to the current stack frame's canary which would cause a fault that would be detected by the next check of that stack canary.

To illustrate, pseudo source code:
if (result <0){goto foo;}else{return 12;}
   can be rewritten by a code generator as:

| CanaryType oldcanaryvalue = current canary value; | |
|---|---|
| current canary value \hat{ }= min(result, 0); | |
| return 12; | // try to return 12, but should end up in |
| | // “wrong canary” code if result < 0 |

In this example, a precondition for the “return” instruction is that the stack canary is equal to its original value and “wrong canary” code (implemented in software) may check to see if the precondition is violated (e.g., an incorrect canary value). The “wrong canary” code may also determine how to respond to the violated precondition. In an example execution of the code above, if result <0 then the stack canary may be reset to “oldcanaryvalue” and the code may execute the “goto foo” instruction. If result >=0, then the stack canary has been corrupted and the “wrong canary” code continues accordingly.

In other aspects, other software such as an operating system or an application may respond as long as the software is provided access to certain values (e.g., oldcanaryvalue and/or result). In other aspects, instead of using a stack canary check, an array-out-of-bounds check or some other check may be used.

According to various aspects of the subject technology, the programming technique may be used by any code generator. For example, in some aspects, a human programmer may use the programming technique. In other aspects, a program such as a compiler may take source code written by a programmer or other software and translate the source code using the programming technique. A human programmer may not even know that the programming technique is being used.

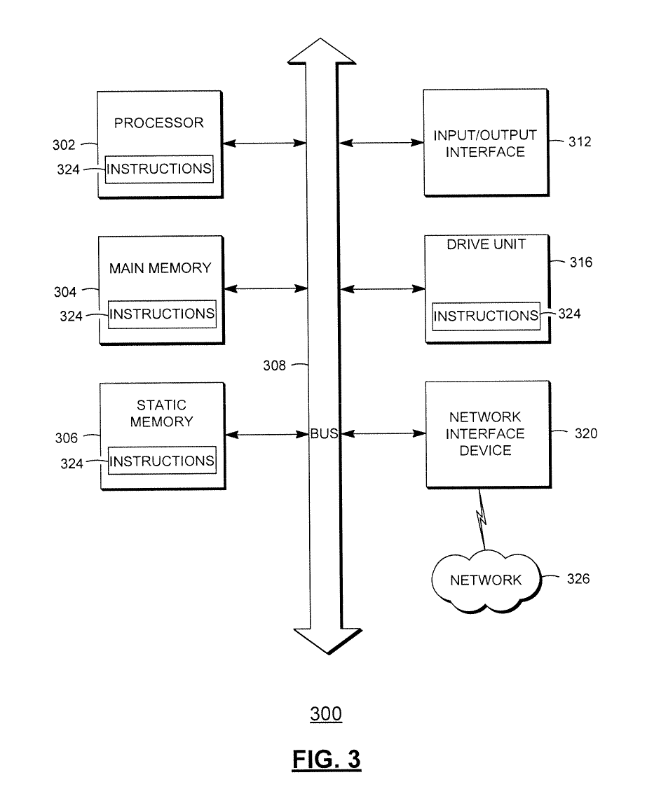

FIG. 3 is a block diagram illustrating a computer system 300 with which any of the clients, servers, or systems described herein may be implemented. In certain aspects, the computer system 300 may be implemented using hardware or a combination of software and hardware, either in a dedicated server, or integrated into another entity, or distributed across multiple entities.

The example computer system 300 includes a processor 302, a main memory 304, a static memory 306, a disk drive unit 316, and a network interface device 320 which communicate with each other via a bus 308. The computer system 300 may further include an input/output interface 312 that may be configured to communicate with various input/output devices such as video display units (e.g., liquid crystal (LCD) displays, cathode ray tubes (CRTs), or touch screens), an alphanumeric input device (e.g., a keyboard), a cursor control device (e.g., a mouse), or a signal generation device (e.g., a speaker).

Processor 302 may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

A machine-readable medium (also referred to as a computer-readable medium) may store one or more sets of instructions 324 embodying any one or more of the methodologies or functions described herein. The instructions 324 may also reside, completely or at least partially, within the main memory 304 and/or within the processor 302 during execution thereof by the computer system 300, with the main memory 304 and the processor 302 also constituting machine-readable media. The instructions 324 may further be transmitted or received over a network 326 via the network interface device 320.

The machine-readable medium may be a single medium or multiple media (e.g., a centralized or distributed database, and/or associated caches and servers) that store the one or more sets of instructions. The machine-readable medium may comprise the drive unit 316, the static memory 306, the main memory 304, the processor 302, an external memory connected to the input/output interface 312, or some other memory. The term “machine-readable medium” shall also be taken to include any non-transitory medium that is capable of storing, encoding or carrying a set of instructions for execution by the machine and that cause the machine to perform any one or more of the methodologies of the embodiments discussed herein. The term “machine-readable medium” shall accordingly be taken to include, but not be limited to, storage mediums such as solid-state memories, optical media, and magnetic media.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system.

Skilled artisans may implement the described functionality in varying ways for each particular application. For example, the modules may include software instructions encoded in a medium and executed by a processor, computer hardware components, or a combination of both. The modules may each include one or more processors or memories that are used to perform the functions described below. According to another aspect, the various systems and modules may share one or more processors or memories. Various components and blocks may be arranged differently (e.g., arranged in a different order, or partitioned in a different way) all without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” may be used herein to mean “serving as an example or illustration.” Any aspect or design described herein as “exemplary” is not necessarily to be construed as All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

1. A non-transitory machine-readable medium comprising instructions stored therein, which when executed by a processor, cause the processor to perform operations comprising:
determining whether a condition exists within a first portion of code;
causing, if the condition exists, a second portion of code to intentionally fail when executed by a processor; and
executing the second portion of code, wherein the executing of the second portion of code fails if the condition exists.

2. The non-transitory machine-readable medium of claim 1, wherein the executing of the second portion of code does not fail if the condition does not exist.

3. The non-transitory machine-readable medium of claim 1, wherein the second portion of code is a function call.

4. The non-transitory machine-readable medium of claim 3, wherein the causing of the second portion of code to fail comprises changing a variable needed by the function call to an invalid value.

5. The non-transitory machine-readable medium of claim 3, wherein the causing of the second portion of code to fail comprises changing a memory location needed by the function call to an invalid memory location.

6. The non-transitory machine-readable medium of claim 5, wherein the invalid memory location is a memory location for non-executable code.

7. The non-transitory machine-readable medium of claim 1, wherein the instructions stored on the machine-readable medium are generated by a compiler based on a source code.

8. The non-transitory machine-readable medium of claim 7, wherein the source code includes a branch operation.

9. The non-transitory machine-readable medium of claim 8, wherein the branch operation comprises instructions to execute code associated with a failure if a condition is met.

10. The non-transitory machine-readable medium of claim 1, wherein the operations further comprise:
generating, if the second portion of code fails, a fault message; and
providing the fault message to an operating system, wherein the operating system may be configured to receive the fault message and execute a response based on the received fault message.

11. A computer-implemented method for coding a conditional branch, the method comprising:
generating a programming code configured to:
determine whether a condition exists in a first portion code;
cause, if the condition exists, a second portion of code to intentionally fail when executed by a processor; and
execute the second portion of code, wherein the executing of the second portion of code fails if the condition exists.

12. The computer-implemented method of claim 11, wherein the executing of the second portion of code does not fail if the condition does not exist.

13. The computer-implemented method of claim 11, wherein the second portion of code is a function call.

14. The computer-implemented method of claim 11, wherein the programming code is generated by a compiler based on a source code.

15. The computer-implemented method of claim 14, wherein the source code includes a branch operation.

16. The computer-implemented method of claim 11, further comprising generating a programming code configured to:
generate, if the second portion of code fails, a fault message; and
provide the fault message to an operating system, wherein the operating system may be configured to receive the fault message and execute a response based on the received fault message.

17. A system for executing a programming code, the system comprising:
a processor; and
a machine-readable medium comprising instructions stored therein, which when executed by a processor, cause the processor to perform operations comprising:
determining whether a condition exists within a portion of the programming code;
changing, if the condition exists, a value used by a subsequent line of the programming code to cause the subsequent line of programming code to intentionally fail when subsequently executed by a processor; and
executing the subsequent line of the programming code, wherein the executing of the subsequent line of the programming code fails if the condition exists and the executing of the subsequent line of the programming code does not fail if the condition does not exist.

18. The system of claim 17, wherein the programming code is generated by a compiler based on a source code.

19. The system of claim 17, wherein the subsequent line of the programming code is a function call.

20. The system of claim 17, wherein the operations further comprise:
generate, if the subsequent line of the programming code fails, a fault message; and
provide the fault message to an operating system, wherein the operating system may be configured to receive the fault message and execute a response based on the received fault message.
